(19) United States
(12) Patent Application Publication
(10) Pub. No.: US 2005/0206663 A1
(43) Pub. Date: Sep. 22, 2005

(54) Automotive user terminal and base station with associated printer

(75) Inventor: Kia Silverbrook, Balmain, NSW (AU)

Correspondence Address: SILVERBROOK RESEARCH PTY LTD, 393 DARLING STREET, BALMAIN, 2041, AU

(73) Assignee: Silverbrook Research Pty Ltd, Balmain, NSW (AU)

(21) Appl. No.: 10/503,925

(22) PCT Filed: Feb. 12, 2003
(86) PCT No.: PCT/AU03/00167

§ 371 Date: Aug. 9, 2004

(30) Foreign Application Priority Data
Feb. 13, 2002 (AU) PS 0499

(51) Int. Cl. B41J 3/00

(52) U.S. Cl. 347/2

(57) ABSTRACT

An information retrieval system records at a predetermined location, particulars relating to an incident which has occurred at the predetermined location. The system includes a user terminal for recording particulars of the incident. A data collecting unit with which the user terminal communicates collects data relevant to the incident. A processor, in communication with the data collecting unit, processes the collected data to provide formatted data suitable for printing. A printing unit is associated with the user terminal for printing, at the location of the incident, the formatted data to provide information relating to the incident.

### FIELD OF THE INVENTION

The present invention relates to an information retrieval system for recording, at a predetermined location, particulars of an incident which has occurred at said predetermined location and to a method of retrieving such information.

In this specification, unless the context clearly indicates otherwise, the term “conveyance” is to be understood in a broad sense as any suitable device for conveying persons and/or goods and includes road vehicles, aircraft, rail vehicles, waterborne craft, space craft or the like.

### BACKGROUND TO THE INVENTION

In many countries, a law enforcement officer needing to issue a form of traffic violation notice is still required to resort to techniques that necessitate manually writing out said infringement notices on a notice pad and providing one copy of the notice to the driver of the vehicle and another copy to data entry personnel for records to be kept of the traffic infringement or violation.

Both copies of the notice are filled in with details such as the identity of the driver of the vehicle involved, the mailing address of the driver, a license number of the driver, registration details of the vehicle, a location of the incident, the time and date of the incident, the nature of the incident and the identification of the law enforcement officer concerned.

A first copy of the infringement notice is provided to the driver of the vehicle and is retained by the driver as a form of invoice for paying a fine at a later stage and for using such notice as a reference in payment of the fine. The second copy of the infringement notice is forwarded to data entry personnel who are in charge of copying the data contained in the infringement notice into a record at a central repository to enable a notification of the traffic violation or infringement to be forwarded by mail to a home address of the vehicle owner at a later stage.

### CO-PENDING APPLICATIONS

Various methods, systems and apparatus relating to the present invention are disclosed in the following co-pending applications filed by the applicant or assignee of the present invention simultaneously with the present application:

| | | | | | |
|---|---|---|---|---|---|
| AP39 | AP43 | AP44 | AP46 | AP47 | AP48 |
| AP49 | AP50 | AF51 | AP52 | AP53 | AP55 |
| AP58 | AP60 | AP61 | AP62 | AP63 | AP64 |
| AP65 | AP66 | AP67 | AP68 | AP69 | AP70 |
| AP71 | AP77 | AP78 | AP79 | | |

The disclosures of these co-pending applications are incorporated herein by cross-reference. Each application is temporarily identified by its file reference. This will be replaced by the corresponding PCT Application Number when available.

### RELATED PATENT APPLICATIONS AND PATENTS

| | | | |
|---|---|---|---|
| US6,227,652 | US6,213,588 | US6,213,589 | US6,231,163 |
| US6,247,795 | US6,394,581 | US6,244,691 | US6,257,704 |
| US6,416,168 | US6,220,694 | US6,257,705 | US6,247,794 |
| US6,234,610 | US6,247,793 | US6,264,306 | US6,241,342 |
| US6,247,792 | US6,264,307 | US6,254,220 | US6,234,611 |
| US6,302,528 | US6,283,582 | US6,239,821 | US6,338,547 |
| US6,247,796 | US09/113,122 | US6,390,603 | US6,362,843 |
| US6,293,653 | US6,312,107 | US6,227,653 | US6,234,609 |
| US6,238,040 | US6,188,415 | US6,227,654 | US6,209,989 |
| US6,247,791 | US6,336,710 | US6,217,153 | US6,416,167 |
| US6,243,113 | US6,283,581 | US6,247,790 | US6,260,953 |
| US6,267,469 | US6,273,544 | US6,309,048 | US6,420,196 |
| US6,443,558 | US09/422,892 | US6,378,989 | US09/425,420 |
| US09/422,893 | US09/609,140 | US6,409,323 | US6,281,912 |
| US09/575,113 | US6,318,920 | US6,488,422 | US09/693,644 |
| US6,457,810 | US6,485,135 | US09/112,763 | US6,331,946 |
| US6,246,970 | US6,442,525 | US09/505,951 | US09/505,147 |
| US09/505,952 | US09/575,108 | US09/575,109 | US09/575,110 |
| US09/607,985 | US6,398,332 | US6,394,573 | US09/606,999 |
| US6,238,044 | US6,425,661 | US6,390,605 | US6,322,195 |
| US09/504,221 | US6,480,089 | US6,460,778 | US6,305,788 |
| US6,426,014 | US6,364,453 | US6,457,795 | US09/556,219 |
| US09/556,218 | US6,315,399 | US6,338,548 | US09/575,190 |
| US6,328,431 | US6,328,425 | US09/575,127 | US6,383,833 |
| US6,464,332 | US6,390,591 | US09/575,152 | US6,328,417 |
| US6,322,194 | US09/575,177 | US09/575,175 | US6,417,757 |
| US09/608,780 | US6,428,139 | US09/607,498 | US09/693,079 |
| US09/693,135 | US6,428,142 | US09/692,813 | US09/693,319 |
| US09/693,311 | US6,439,908 | US09/693,735 | PCT/AU98/00550 |
| PCT/AU00/00516 | PCT/AU00/00517 | PCT/AU00/00511 | PCT/AU00/00754 |
| PCT/AU00/00755 | PCT/AU00/00756 | PCT/AU00/00757 | PCT/AU00/00095 |
| PCT/AU00/00172 | PCT/AU00/00338 | PCT/AU00/00339 | PCT/AU00/00340 |
| PCT/AU00/00341 | PCT/AU00/00581 | PCT/AU00/00580 | PCT/AU00/00582 |
| PCT/AU00/00587 | PCT/AU00/00588 | PCT/AU00/00589 | PCT/AU00/00583 |
| PCT/AU00/00593 | PCT/AU00/00590 | PCT/AU00/00591 | PCT/AU00/00592 |
| PCT/AU00/00584 | PCT/AU00/00585 | PCT/AU00/00586 | PCT/AU00/00749 |
| PCT/AU00/00750 | PCT/AU00/00751 | PCT/AU00/00752 | PCT/AU01/01332 |
| PCT/AU01/01318 | PCT/AU00/01513 | PCT/AU00/01514 | PCT/AU00/01515 |
| PCT/AU00/01516 | PCT/AU00/01517 | PCT/AU00/01512 | PCT/AU01/00502 |
| PCT/AU02/01120 | PCT/AU00/00333 | PCT/AU01/00141 | PCT/AU01/00139 |
| PCT/AU01/00140 | PCT/AU00/00753 | PCT/AU01/01321 | PCT/AU01/01322 |
| PCT/AU01/01323 | PCT/AU00/00594 | PCT/AU00/00595 | PCT/AU00/00596 |
| PCT/AU00/00597 | PCT/AU00/00598 | PCT/AU00/00741 | PCT/AU00/00742 |

### SUMMARY OF THE INVENTION

According to a first aspect of the invention, there is provided an information retrieval system for recording, at a predetermined location, particulars relating to an incident which has occurred at said predetermined location, the system including:
a user terminal for recording particulars of the incident;
a data collecting means with which the user terminal communicates for collecting data relevant to the incident;
a processing means, in communication with said data collecting means, for processing said collected data to provide formatted data suitable for printing; and
a printing unit associated with said user terminal for printing, at the location of said incident, said formatted data to provide information relating to said incident.

Preferably, the system is carried in a conveyance, the user terminal being a portable unit for removal and use externally of the conveyance. The printing unit may be incorporated in the user terminal. Instead, the printing unit may be built into the conveyance.

The data collecting means may include a location determining unit for determining said predetermined location. The location determining unit may provide data regarding the location as a set of co-ordinates. Hence, the location determining unit may comprise a global positioning system (GPS) receiver.

The data collecting means may further include an accessing means for accessing at least one database for obtaining further data relevant to the incident. The accessing means may include a communications sub-system for accessing at least one remote database. The communications sub-system may be a wireless sub-system incorporated into the conveyance.

The processing means may include a layout engine in communication with the user terminal. The layout engine may perform, according to predetermined information, layout of data elements to be communicated to the printer so that, when printed on a suitable print media, the data are presented in a visually discernible form.

The processing means may further comprise a data manipulating means in communication with the layout engine for manipulating the data to provide the formatted data.

The printing unit may include a printer controller, for receiving the formatted data to be printed, and a printer.

The printer may be a full color printer. Preferably, the printer is a photo quality color printer.

Further, the printer may be an ink jet printer. Thus, the printer may comprise a pagewidth ink jet printhead. The printhead may comprise an array of nozzles, said array being fabricated by microelectromechanical techniques.

According to a second aspect of the invention, there is provided a method of retrieving information, at a predetermined location, of particulars relating to an incident which has occurred at the predetermined location, the method including the steps of:
recording particulars of the incident that has occurred at said predetermined location;
collecting data relevant to the incident;
processing said collected data to provide formatted data suitable for printing; and
printing said formatted data, at said location of the incident and when required by a user, to provide the user with information relating to said incident.

Preferably, a user terminal is mounted in a conveyance, a printer is associated with the user terminal and the method includes printing the information via said printer.

The method may include determining the location of the incident. Thus, the method may include providing the location of the incident as a set of co-ordinates.

The method may further include accessing at least one database for obtaining further data relevant to the incident. Hence, the method may include accessing at least one database remote from the location of the incident for obtaining further data relevant to the incident.

Further, the method may include performing, according to predetermined information, layout of content to be communicated to the printer so that, when printed on a suitable print media, the data are presented in a visually discernible form. Then, the method may include manipulating said data prior to printing the data to provide said formatted data.

According to a third aspect of the invention, there is provided an information retrieval system for recording, at a predetermined location, particulars relating to an incident which has occurred at said predetermined location, the system being mounted in a vehicle and the system including:
a user terminal for recording particulars of the incident at said predetermined location, the user terminal being demountably arranged relative to the vehicle;
an onboard data collecting means with which the user terminal communicates for collecting data relevant to the incident;
a processing means, in communication with said data collecting means, for processing said collected data to provide formatted data suitable for printing; and
a printing unit arranged in said user terminal for printing said formatted data to provide information relating to said incident.

In this specification, unless the context clearly indicates otherwise, the term “onboard” is to be understood in a broad sense as a device and its components that are mounted in the vehicle.

The data collecting means may include a location determining unit for determining the location of the vehicle.

The system may further include a wireless communications sub-system for accessing at least one remote database to obtain details of at least one of a person involved in said incident and another vehicle involved in said incident By “another vehicle” is meant a vehicle other than that carrying the system.

According to a fourth aspect of the invention, there is provided a method of retrieving information, at a predetermined location and from a vehicle located at the location, of particulars relating to an incident which has occurred at the predetermined location, the method including the steps of:
recording, on a user terminal associated with said vehicle, particulars of the incident that has occurred at said predetermined location;
collecting data relevant to the incident;
processing said collected data to provide formatted data suitable for printing; and
printing said formatted data on a printer of the user terminal when required by a user to provide the user with information relating to said incident.

The method may include determining the location of the vehicle.

The method may further include accessing at least one remote database to obtain details of at least one of a person involved in said incident and another vehicle (as defined) involved in said incident.

According to fifth aspect of the invention, there is provided a system for retrieving and recording information relating to a traffic violation, the system being installed in a vehicle and the system including:
a user terminal operable by a user of the vehicle to record details of the traffic violation, the user terminal being demountably arranged relative to the vehicle;
a position sensing means carried by the vehicle for sensing the position of the vehicle to provide location data to the user terminal;
an accessing means, in communication with the user terminal, for accessing a database containing details of at least one of a driver which has committed the traffic violation and a vehicle involved in said traffic violation;
a layout engine responsive to the accessing means for processing data at least into textual data;
a pre-printing processing means which is connected to the layout engine and which processes the data from the layout engine to provide formatted data which is in a format which is suitable for printing; and
a printer contained in the user terminal for printing the formatted data, on demand, to provide at least one hard copy of a traffic infringement notice.

According to a sixth aspect of the invention, there is provided a method of retrieving and recording, from a vehicle, information relating to a traffic violation, the method including the steps of:
recording details of the traffic violation on a user terminal operable by a user of the vehicle, the user terminal being demountably arranged relative to the vehicle;
sensing the position of the vehicle to provide location data to the user terminal;
accessing a database containing details of at least one of a driver which has committed the traffic violation and a vehicle involved in said traffic violation;
processing data at least into textual data by means of a layout engine;
further processing the data from the layout engine to provide formatted data which is in a format which is suitable for printing; and
printing, on a printer contained in the user terminal the formatted data, on demand, to provide at least one hard copy of a traffic infringement notice.

### BRIEF DESCRIPTION OF THE DRAWINGS

A preferred embodiment of the invention will now be described, by way of example only, with reference to the accompanying drawings, in which.

FIG. 1 shows a block diagram of an information retrieval system, in accordance with the invention, for recording, at a predetermined location, particulars of an incident that has occurred at the predetermined location;

FIG. 2 shows a three dimensional view of a printer for use with the system;

FIG. 3 shows a three dimensional view of the printer with a cover removed;

FIG. 4 shows a three dimensional, exploded view of the printer;

FIG. 5 shows a sectional side view of the printer,

FIG. 6 shows a three dimensional view of a cartridge for the printer;

FIG. 7 shows a three dimensional, exploded view of the cartridge;

FIG. 8 shows a three dimensional, schematic view of a nozzle assembly for an ink jet printhead for the printer;

FIGS. 9 to 11 show a three dimensional, schematic illustration of an operation of the nozzle assembly of FIG. 8;

FIG. 12 shows a three dimensional view of a nozzle array constituting the printhead;

FIG. 13 shows, on an enlarged scale, part of the array of FIG. 12;

FIG. 14 shows a three dimensional view of the printhead including a nozzle guard;

FIG. 15 shows a schematic diagram of one embodiment of a position sensing system for use with the information retrieval system of FIG. 1;

FIG. 16 shows a schematic diagram of another embodiment of a position sensing system dor use with the information retrieval system of FIG. 1;

FIG. 17 shows a schematic block diagram of a wireless communications sub-system forming part of the system of FIG. 1; and

FIG. 18 shows a three dimensional view of an implementation of the information retrieval system.

### DETAILED DESCRIPTION OF PREFERRED EMBODIMENT

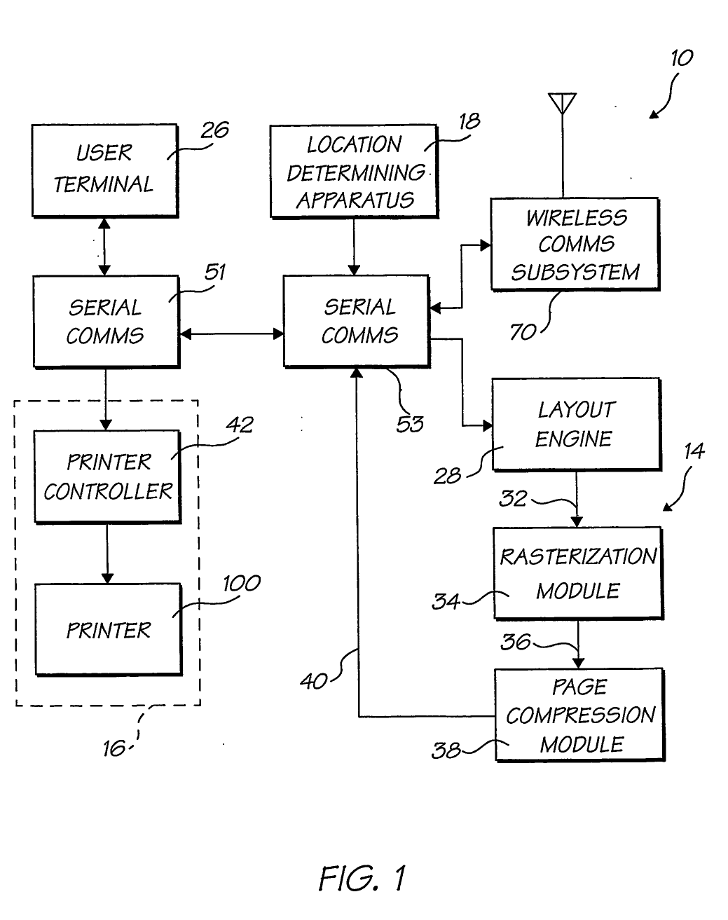

In FIG. 1, reference numeral 10 generally designates an information retrieval system, in accordance with the invention, for recording, at a predetermined location, particulars of an incident that has occurred at that location. The system 10 is intended particularly for use by law enforcement officers and, more particularly, vehicle borne law enforcement officers.

The system 10 includes a user terminal 26 comprised of a display section and a data entry section. The user terminal 26 is a hand-held or portable device that is used by the law enforcement officer to record particulars of an incident at the location of the incident. The combination of the display section and data entry section of the user terminal 26 provides the law enforcement officer with the ability to enter data regarding the incident and to make certain enquiries regarding the incident, as will be described in greater detail below.

The user terminal is interfaced to an attached printing unit 16 via a serial communications unit 51. The printing unit 16 comprises a printer controller 42 that controls a printer 100 for printing information relating to the incident.

The printing unit 16 can either form part of the hand held user terminal 26 or can be attached to a cradle in the vehicle in which the user terminal 26 is received for enabling data to be downloaded from the user terminal for printing.

The system 10 includes a location determining unit in the form of a position sensing unit 18 that is used by the system 10 for determining data relating to the locality of the incident for enabling this data to be included in a traffic infringement notice to be issued.

A wireless communications sub-system 70 is included in the system 10 and is integrated into the vehicle. The sub-system 70 provides communications between a remote server and the vehicle. The remote server may be accessed by the law enforcement officer to obtain details of the driver and previous offences and also to provide a facility for entering traffic infringement notice data into the remote server.

The system 10 includes a data processing means 14. The data processing means 14 includes a layout engine 28. The layout engine 28 performs layout of content to be printed and generates a description of one or more pages in a page description language such as postscript or PDF. These page descriptions are output on data line 32 to a rasterization module 34 that, in turn, communicates with a page compression module 38 via a data line 36. The modules 34 and 38 perform rasterization and compression of the page description prior to transmission to the printing unit 16. The page compression module 38 communicates with the serial communications unit 51 via a further serial communications unit 53 and a data line 40.

Certain of the components of the system 10 are now described in greater detail.

In the first embodiment of the position sensing unit 18, use is made of the global positioning system (GPS). The GPS consists of 24 satellites orbiting the earth in a fixed pattern such that from any point within range of the GPS, at least four satellites are visible. It is this line-of-sight to at least four satellites that enable the determination of a number of parameters relating to the location of the GPS receiver 18. In FIG. 15 of the drawings, four satellites 50.1-50.4 and their associated transmission foot prints 50.5 to 50.8, respectively, are shown In a two dimensional projection.

Those skilled in the art will understand that each of the satellites 50.1-50.4 contains a high accuracy atomic clock and also ephemeris data. The ephemeris data and the current time are transmitted by each satellite 50.1-50.4 at fixed intervals so that they may be received by the GPS receiver 18. By comparing the time at the GPS receiver 18 with the time received by way of the satellite transmissions, it is possible to calculate the distance between the receiver 18 and each of the satellites 50.1-50.4. With the addition of the ephemeris data, the positions of the satellites 50.1-50.4 are also available. Given these two pieces of information, it is possible to narrow down the position of the receiver 18 to a point on a sphere centred on the satellites 50.1-50.4. With four sets of data from the four satellites 50.1-50.4, the intersections of each of these spheres 50.5-50.8 yields X, Y and Z co-ordinates of the GPS receiver 18 and also an accurate measure of UTC time. A transformation of these co-ordinates yields the receiver's position in terms of latitude, longitude and height above sea level.

To overcome the uncertainty of the GPS created by the introduction of “selective availability” into the GPS by the US military, an enhanced GPS, known as dGPS or differential GPS can be used. This uses a differential signal where it is available. dGPS uses a fixed reference base station equipped with a GPS receiver in addition to a portable receiver. The fixed receiver transmits a signal representing the error in the GPS signal that it receives to the portable receiver. The portable receiver then uses this signal to reduce the error in its position estimation.

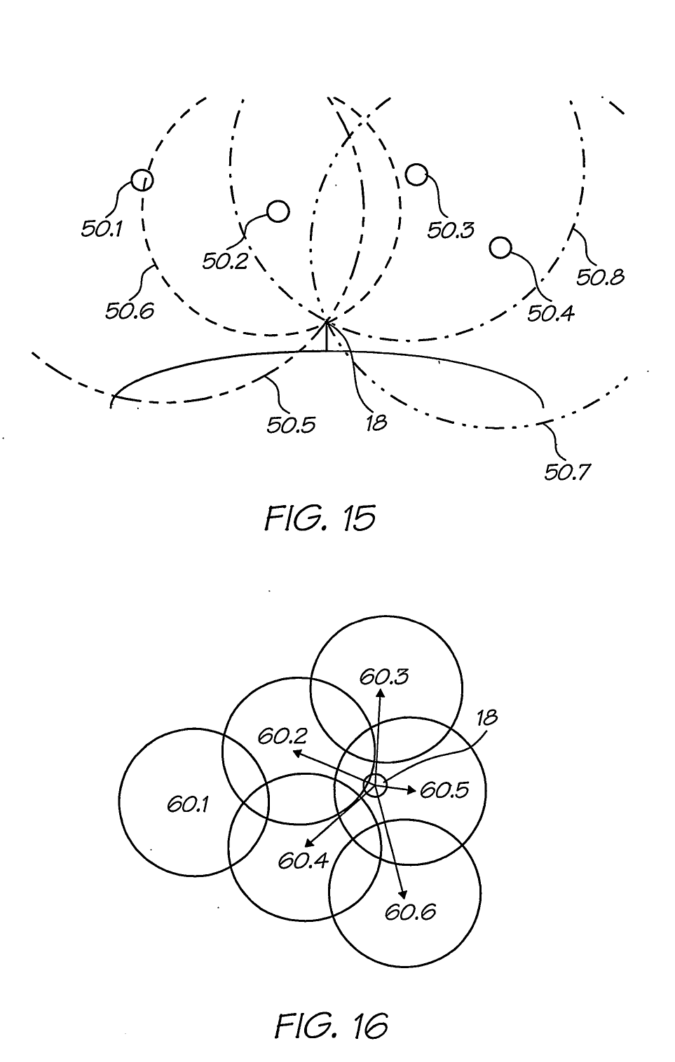

In another embodiment of the invention, instead of using the GPS or in addition to it, a mobile phone network could be used as shown in FIG. 16. It is only possible to use this network in populated areas in which a number of mobile phone base stations are located such as within the boundaries of a city.

A typical mobile telephone network consists of a number of base stations 60.1-60.6 (FIG. 16).

Each base station 60.1-60.6 transmits in a predetermined area or foot print to define a cell. The distance between adjacent base stations is usually arranged so that the size of each cell is large enough to provide a degree of overlap between it and its neighbouring cells. This allows a user to roam over the coverage area whilst still having access to telephone services since they are always in the area of at least one cell.

As a user moves within a cell, the strength of the signal that it receives from that cell varies depending on a number of factors including the distance from a base station 60.1-60.6. As a user moves between cells, the handset typically switches from using the base station corresponding to the cell with a lower signal strength to a base station corresponding to a cell with a higher signal strength in order to maintain service quality.

Given the distribution of cells and the ability of a handset to emit a signal that may be received by more than one base station as it propagates, a traffic controlling mechanism is provided in which the location of a handset may be determined to within a certain degree of accuracy, possibly an accuracy of about ten meters.

A number of different techniques may be employed to locate the handset functioning as a receiver 18. The selected technique depends mainly on the type of technology of the handset and its network. Generally, differences between the time of arrival of access bursts generated by the handset 18 can be used to triangulate the position of the receiver 18 by calculating the distance from three base stations to the receiver 18. The reverse of this technique, whereby the receiver 18 determines its location based on access bursts generated by nearby base stations, can also be used by incorporating specialised location determining functionality into the receiver 18.

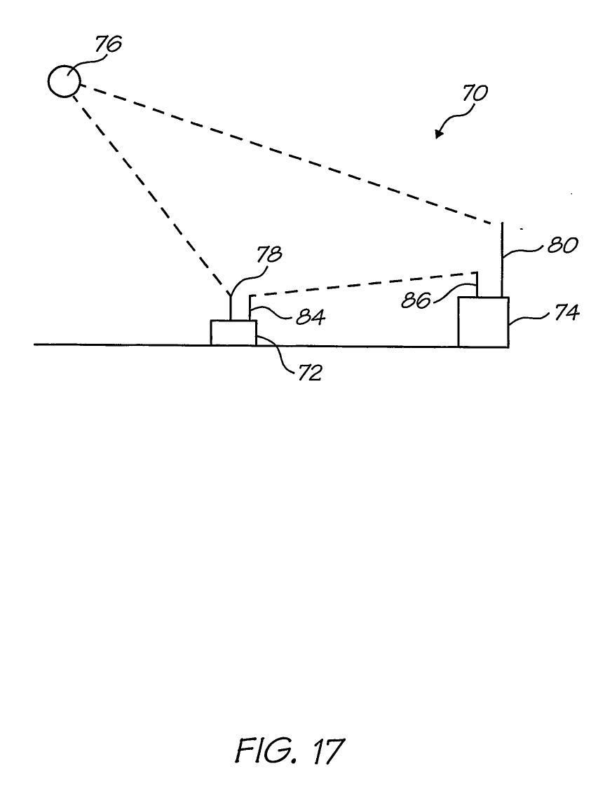

Referring to FIG. 17 of the drawings, various forms of wireless communications sub-system 70 could be employed. One technique is to use a combination of satellite communications and a mobile telephone network.

The sub-system 70 includes a mobile station 72 (being the motor vehicle in this invention) and a fixed station 74. A satellite is designated generally by the reference numeral 76. The satellite 76 communications with the mobile station 72 via a satellite receiver 78. The satellite 76 also communications with the base station 74 via a satellite up link 80.

In addition, the mobile station 72 includes a mobile phone network based transmitter 84, which communicates with a mobile phone network based receiver 86 at the base station 74.

To enable data to be transmitted from the mobile station 72 to the base station 74, satellite transmission via the satellite 76 is employed as well as the mobile telephone network using the transmitter 84 and the receiver 86.

The layout engine 28 may be required to manipulate data sourced from a plurality of sources. This data may have no embedded layout information. Depending on the kind of content supplied, it may be necessary to firstly create a formatted description of the content which can then be used to generate one or more pages of page description language.

The page description language to be generated by the layout engine 28 determines the kinds of data elements, and the structuring of elements that may be used to compose a page. For example, if the page description language used is postscript then the elements that are used to describe the page include filled and stroked paths consisting of line segments and curves, text with corresponding font definitions, and images.

A template for laying out data may be dynamically generated by the layout engine 28 based on user choices, may be a static built-in template, or may even be obtained from some other source such as the source suppling the data.

A number of possibilities exist for layout and content descriptions that can be used to generate a set of consistent layouts for a page containing a number of elements, which may be both textual and graphical.

One example of a method of data layout that allows data to be sourced from a plurality of separate locations is through using a combination of XML (eXtensible Markup Language) and XSL (extensible Stylesheet Language).

XML allows content to be marked up by applying a set of tags to the content. The definition of each tag in particular XML content is described in a separate scheme referenced by the XML.

XSL provides a method of transforming XML into another format (for example HTML) whilst simultaneously performing selection and filtering operations.

The combination of XML content and XSL as a layout specification allows for descriptions of one or more pages to be produced in a formatting language. The formatting language may then be translated into a page description language suitable for printing (ie, one that provides descriptions of objects, their locations and compositing details).

Another possible layout and content description which can be used is a document which is specified in HTML (Hyper Text Markup Language) which is supplied to the layout engine 28 for the purposes of creating a page description. One or more stylesheets specified according to CSS (Cascading Style Sheet) standard may also be supplied, allowing the layout engine 28 to associate a supplied style with a set of tags. If no style sheet is supplied a set of default styles internal to the layout engine 28 is adopted.

The HTML document is then translated into a page description language suitable for printing.

The rasterization module 34 is provided to convert from page description language into a format that can be sent to the print engine (not shown) of the printer 100. This format may take a number of forms depending on the characteristics of the print engine such as the color gamut of the output device, the types of markers to be used, the number of markers being used (and their respective colors) and the medium being marked.

The page description received by the rasterization module 34 may also take a number of forms. Many page description languages are program oriented in that a page is described in a pragmatically generated manner. Other page description languages describe pages in terms of a set of objects placed on a page by way of a painter's algorithms. Still other page description languages describe a page in terms of a compositing model that defines a hierarchy of objects located on a page, each with a defined compositing order relative to a neighbourhood of other objects.

A number of ways exist in which rasterization of a page, a set of pages, a sub-set of objects on a page or a sub set of objects on a number of pages may be processed by the rasterization module 34.

One method of rasterization involves a divide-and-conquer approach in which the page description language is initially interpreted to form a model of the page. The page is scanned and objects are rasterized as they are encountered and then composited to form pixmap output for a portion of the page. The pixmap is then mapped into the color space of the output device or dithered (or error defused) to match the characteristics required by the output device.

Another method of rasterization which may be employed by the rasterization module 34 is to render each object in full or partially according to the type of object the coverage of the object with respect to the page (and the portion of the page currently being rendered) and caching aspects of the object For instance, if a character string is to be rasterized, each character in the string may be rasterized in full and then cached for later reuse whereas a filled rectangle may only be rasterized as necessary.

Depending on the output requirements for the rasterization module 34, each page to be rasterized may be generated in its entirety or generated in a band wise fashion for forwarding to the page compression module 38. In this way, if a page is larger than a certain size, and memory needs to be conserved, a page may be divided into a number of bands that may be rasterized on demand.

The page compression module 38 is provided to reduce the amount of rasterized page data that needs to be transferred to the printer controller 42. The page data is compressed using one or more of a number of techniques that do not result in a visible degradation in the quality of the final printed image.

A method of compressing contone data is JPEG compression. With this compression technique, contone pixels are converted into a luminance/chrominance representation which may then efficiently be compressed by using quantization of a discrete cosine transformation of the data. This quantized version of the data is entropy coded to reduce large runs of zero valued elements resulting in an overall 10:1 reduction in data size with virtually no resulting significant loss of image quality.

The wavelet transform, as adopted by the JPEG 2000 standard, is a method used to compress contone data. Two different wavelet transforms are specified by JPEG 2000, namely, a 9/7 wavelet transform for lossy compression and a 5/3 3 wavelet transform for lossless compression. Given that the results of compression using the 9/7 wavelet transform are visually superior to the results of compression using the discrete cosine transform, it is reasonable to expect that a compression ratio of at least 50:1 can be achieved without significant degradation of the reconstructed image.

The scan order adopted by JPEG 2000 is a spiral scan of the original image, traversed one pixel at a time. This is not convenient for printing applications since it would require that the complete page be decoded and stored or that the page be decoded multiple times for printing to be carried out To remedy this, it may be possible to adopt an alternative scan order that traverses each image row in sequence such that each portion of the image received can be immediately decoded and printed independently of the receipt of the complete compressed page.

Compression of bilevel images may be performed by using the commonly known Group 3 or Group 4 fax algorithms. These algorithms exploit the two dimensional properties of typical bilevel images to achieve an average 30:1 compression.

The JBIG (Joint Bilevel Image Group) has defined a method for the compression of bilevel images called JBIG2 that is able to yield higher compression ratios than the older Group 3 and Group 4 fax algorithms with a more complex encoder/decoder combination. Essentially JBIG2 relies on the encoder to successfully segment an input image into a number of regions that are compressed with techniques specialised according to the properties of the region being encoded. Regions that contain text elements are encoded using an algorithm that stores encoded versions of bitmaps corresponding to each character. Regions that contain half toned images (particularly for the case when ordered half toning has been used) are encoded by storing a dictionary of half toned patterns and the regions to which they apply. Regions that contain other elements such as line art are encoded into a compressed bitmap representation.

In certain instances, page compression may not be required. In that case, the page compression module 38 functions using null compression wherein the page is not compressed at all and the page compression module 38 functions as a pass through module.

The printer controller 42 is responsible for handling the hardware specific aspects of the printing process. This enables a number of different types of printing mechanisms or printers 100 to be adopted without changing details of the system further up the chain of print modules.

The printer controller 42 receives a rasterized version of each page which is usually compressed using one of the compression techniques described above. The page may be received in its entirety or in a band-wise fashion depending on the size of the page and the functioning of the preceding modules 34 and 38.

In the printer controller 42, the page data are progressively accessed in printer order, decompressed if required and organised into a format suitable for hardware of the printer 100 to enable the hardware of the printer 100 to program its printhead 300. This recognition may include such factors as may be necessary to account for special characteristics of a particular printhead 300 such as up scaling and dithering of the print data and adjustments, if necessary, for the markers and paper being used.

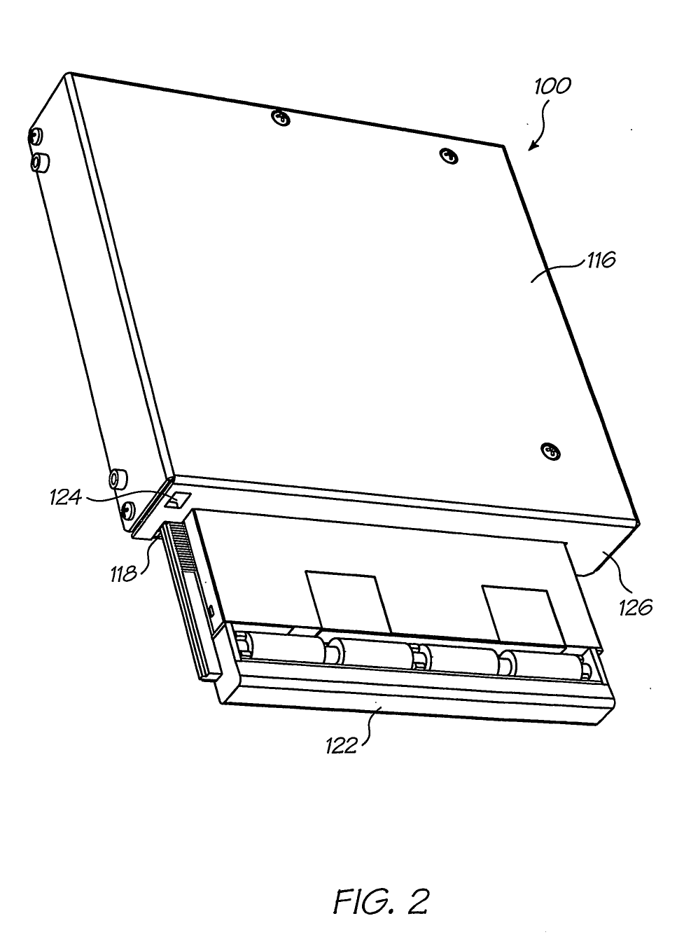

Referring to FIGS. 2 to 7 of the drawings, the printer 100 is described in greater detail.

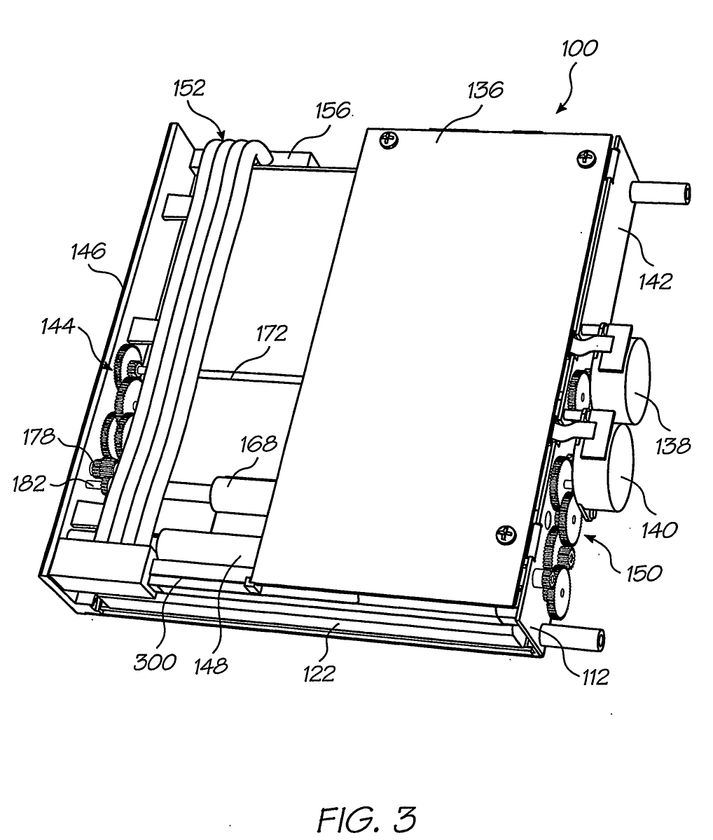

The printer 100 includes a chassis 112 (FIG. 3) which is covered by a top cover 116. The printer 100 has an access opening 118 in the top cover. The access opening 118 is closed off by a flap 120. The flap 120 is spring biased so that, when a cartridge 122 has been removed from the printer 100, the flap is urged upwards to close off the access opening 118.

The device which sends commands to the printer 100 can either be hard wired to the printer 100, for example, via a wiring loom of the motor vehicle or, instead, the device may send commands to the printer 100 in a wireless manner. For this purpose, the printer 100 includes a port 124 able to detect wireless communications, such as infra-red communications.

The printer 100 incorporates a printhead 300 (FIG. 3). The printhead 300 is a pagewidth ink jet printhead. More particularly, the printhead 300 is a four color printhead, or three color plus infra red ink, printhead which prints photo quality prints on print media stored in the cartridge 122. The printhead 300 comprises an array of nozzles to provide printing at 1600 dpi. The nozzles of the printhead 300 are manufactured using the applicant's Memjet technology. In a particularly preferred form, the printhead includes Memjet technology as described in the patent applications and patents as listed in the paragraph headed “Related Patent Applications and Patents”, at page 2, the disclosure of which is incorporated herein by way of explicit reference.

The printhead 300 receives commands from a printed circuit board (CB) 136 secured to the chassis 112.

A pair of drive motors 138 and 140 is mounted on a sidewall 142 of the chassis 112. The drive motor 138, which is in the form of a stepper motor, drives a first drive arrangement in the form of a first gear train 144. The first gear train 144 is mounted on a side molding 146 of the chassis 112.

The drive motor 140, which is also in the form of a stepper motor, drives a drive roller 148 via a second drive arrangement in the form of a second gear train 150.

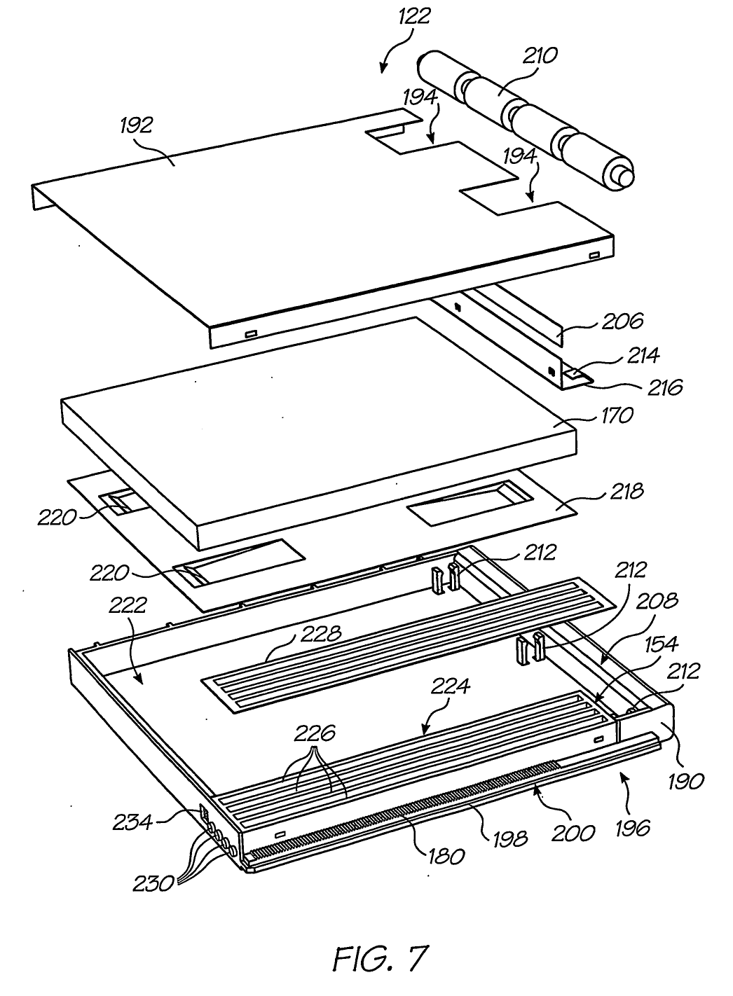

The printhead 300 receives ink from ink hoses 152 which communicate with an ink supply reservoir 154 (FIG. 7) of the cartridge 122 via an ink supply manifold 156, as will be described in greater detail below.

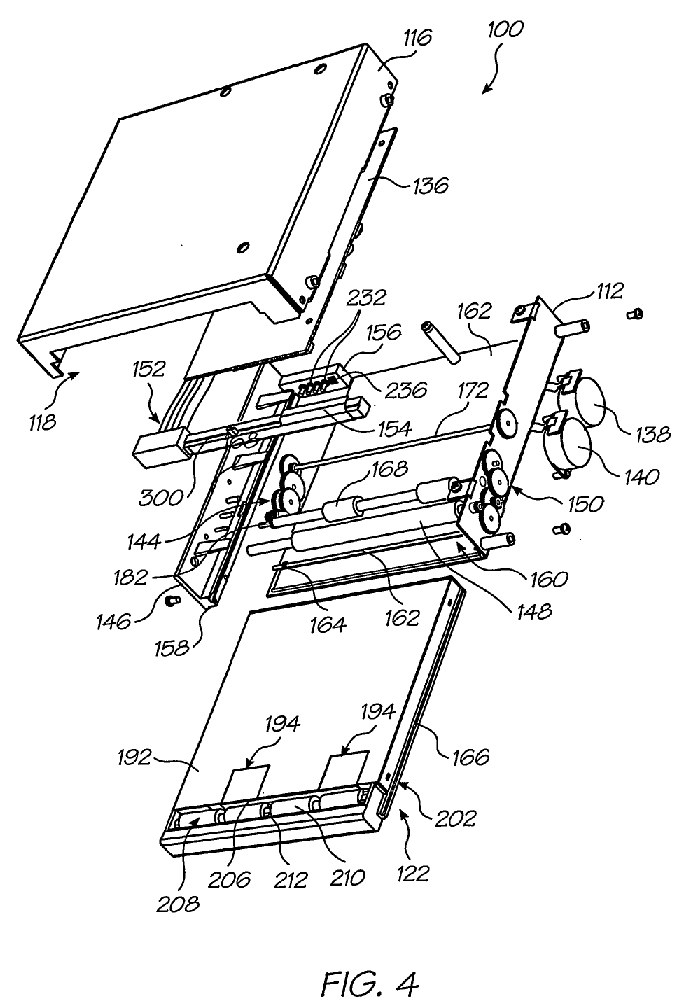

Referring to FIG. 4 of the drawings, an exploded view of the printer 100 is illustrated. It is to be noted that the printhead 300 communicates with the PCB 136 via a TAB film 154.

A slot 158 is defined in the side molding 146. The slot 158 receives a corresponding formation of the cartridge 122 in it Further, a roller set 160 is mounted on a base 162 of the printer 100. The roller set 160 comprises a rotatable axle 162. A cog 164 is mounted proximate each end of the axle 162. Each cog 164 engages a longitudinally extending rack 200, 202, one on each side of the cartridge 122, for inhibiting skewing of the cartridge 122 as it is inserted into, or withdrawn from, the printer 100.

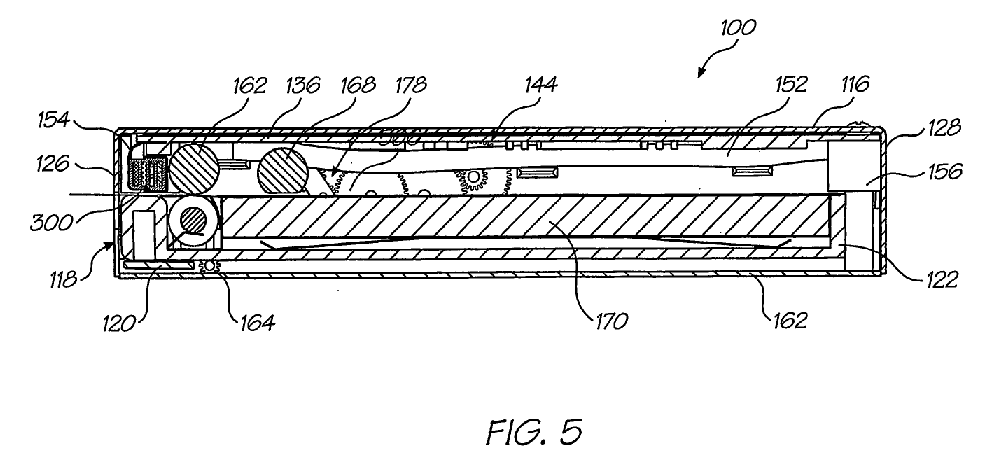

The first gear train 144 engages a pick up roller 168 of the printer 100. The pick up roller 168 picks up print media in the form of a sheet of paper from a stack 170 of paper (FIG. 5) in the cartridge 122 for feeding to the printhead 300 of the printer 100 when printing is to be effected.

As shown in greater detail in FIG. 4 of the drawings, the first gear train 144 is powered by the stepper motor 138 via an axle 172 extending across the printer 100 to convey power from the stepper motor 138 to the first gear train 144. A gear 174 is mounted against the molding 146 at one end of the axle 172. The gear 174 drives a reduction gear set 176. Further, the reduction gear set 176 communicates with a reversing mechanism 178. Accordingly, the gear train 144 performs two functions. When the reversing mechanism 178 is not selected, the gear train 144 engages an upper rack 180 on the cartridge 122 for feeding the cartridge 122 into the printer 100 or ejecting the cartridge 122 from the printer 100. Instead, when the reversing mechanism has been selected, it engages the pick up roller 168 or, more particularly, a gear 182 mounted at an end of the pick up roller 168. The gear train 144 then serves to feed the paper to the drive roller 148 for conveying to the printhead 300.

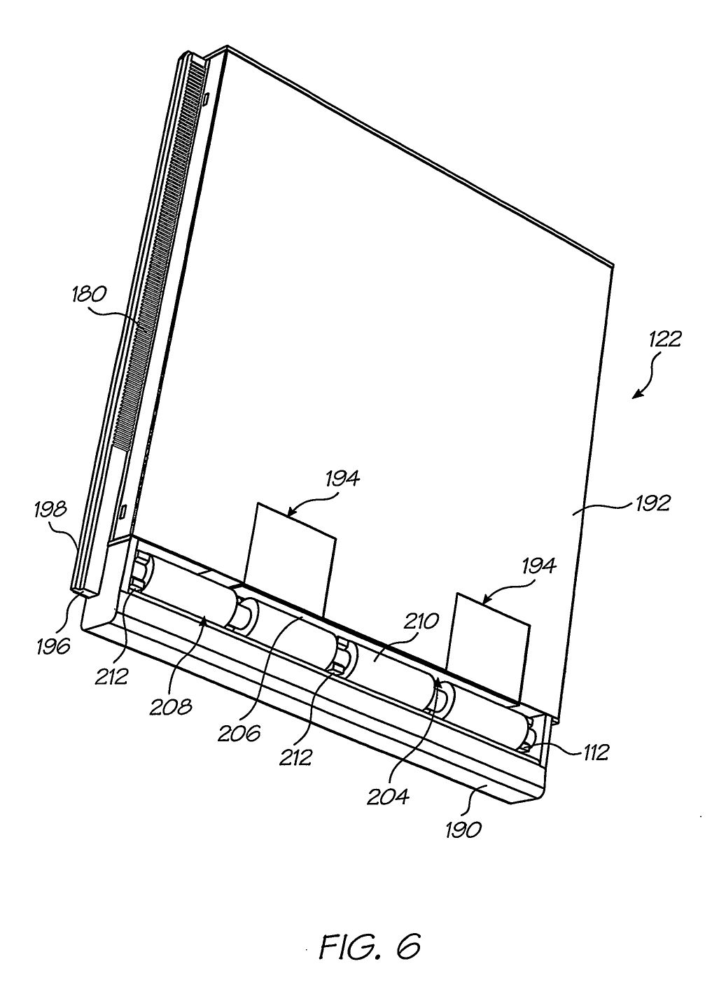

Referring now to FIGS. 6 and 7 of the drawings, the cartridge 122 is described in greater detail.

The cartridge 122 comprises a base molding 190. The base molding 190 is closed off by a metal cover 192. The cover 192 has a pair of transversely spaced openings 194 defined in a front edge thereof. These openings 194 permit the pick up roller 168 of the printer 100 to engage a topmost sheet of the stack 170 of paper within the cartridge 122.

A toothed rack 196 is provided on one side of the cartridge 122. The toothed rack 196 defines the upper rack 180 which is engaged by a gear of the first gear train 144 for insertion of the cartridge 122 into, or its ejection from, the printer 100. A rib 198 extends longitudinally along the side of the toothed rack 196. The rib 198 is received in the slot 158 in the side molding 146 of the printer 100. A lower surface of the toothed rack 196 also has one of the longitudinally extending racks 200 (FIG. 7) for engagement with one of the cogs 164. An opposed side of the base molding 190 of the cartridge 122 carries the other of the longitudinally extending racks 202 which engages the other cog 164 for inhibiting skewing of the cartridge 122 when it is inserted into, or ejected from, the printer 100.

A feed slot 204 is defined at a front edge of the metal cover through which a sheet of paper to be printed is passed in use. The feed slot 204 is partially defined by a plastics strip 206 which inhibits more than one sheet of paper being fed to the printhead 300 at any one time.

A transversely extending trough 208 is defined outwardly of the strip 206. The trough 208 accommodates a sprung roller 210 therein. The roller 210 is supported in the trough 208 via a plurality of clips 212.

The roller 210 is biased upwardly relative to a base of the trough 208 via a plurality of leaf springs 214. The leaf springs 214 are formed integrally with an L-shaped metal bracket 216 which partially forms the trough 208. The roller 210 is a snap-fit in the clips 212.

A platen 218 is accommodated in the base molding 190. The platen 218 is spring biased via a plurality of leaf springs 220 which engage a floor 222 of the base molding 190 for urging the stack 170 of paper against the cover 192.

The ink supply reservoir 154 includes an ink supply molding 224 formed integrally with the base molding 190. The ink supply molding 224 defines a plurality of ink supply channels 226. Each ink supply channel 226 contains a particular color of ink. In this context, the term “color” is to be understood as including inks which are invisible in the visible spectrum such as, for example, infra red inks.

The channels 226 are closed off by a flexible bladder-like membrane 228 which is heat-sealed to the molding 224. It will be appreciated that, as ink is withdrawn from each channel 226, the associated membrane 228 collapses into the channel 226 thereby inhibiting the ingress of air into that channel 226.

Each channel 226 communicates with an ink outlet 230. Each ink outlet 230 is in the form of a rupturable seal.

As shown in greater detail in FIG. 4 of the drawings, the ink supply manifold 156 of the printer 100 includes pins 232. These pins 232 communicate with the ink supply hoses 152. When the cartridge 122 is inserted into the printer 100, and the cartridge 122 is driven home by the gear train 144, the pins 232 pierce the seals 230 to place the hoses 152 in communication with their associated ink supply channels 226.

The cartridge 122 includes a quality assurance chip 234. This chip 234 ensures correct communications between the cartridge 122 and the printer 100 and that the cartridge 122 is of the required quality. The chip 234 communicates with the printer 100 via chip contacts 236 mounted on the ink supply manifold 156 of the printer 100. Thus, when the cartridge 122 is driven home by the gear train 144, the chip 234 engages the contacts 236 for enabling communications to be established between the chip 234 and the circuit board 136 of the printer 100.

The cartridge 122 is a disposable unit so that, once its ink supply and paper supply have been depleted, the cartridge is disposed of. Instead, the cartridge 122 may be re-useable. In the latter case, once the supply of ink and paper in the cartridge 122 have been depleted and the cartridge 122 is ejected from the printer 100, the used, empty cartridge 122 can be taken by a user to a supplier for a refund. It is to be noted that the cartridge 122 is automatically ejected from the printer 100 once its supply of paper and/or ink has been depleted.

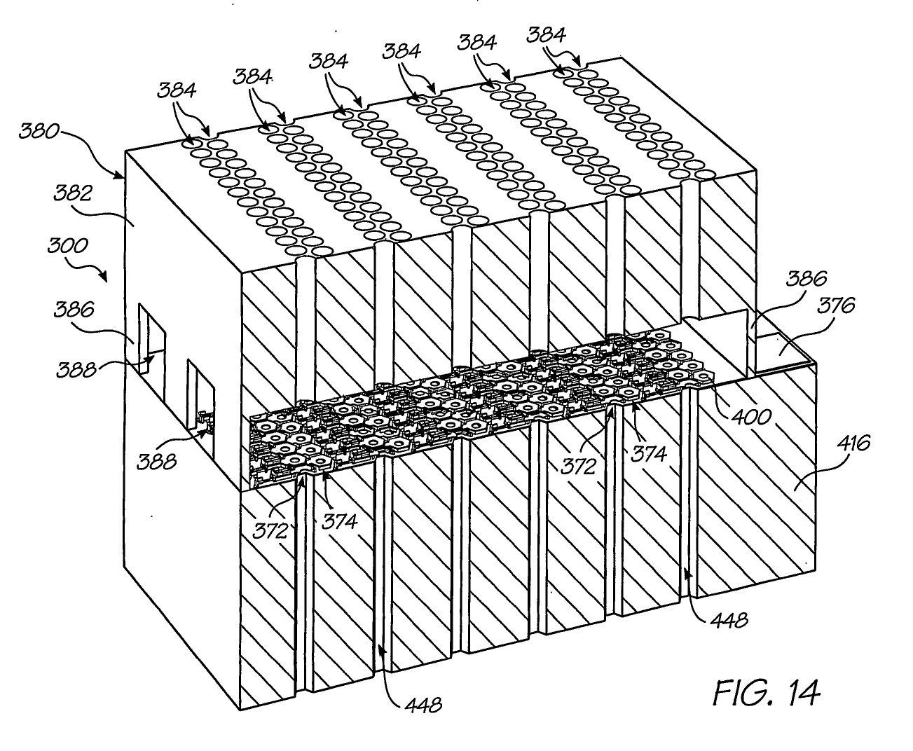

Referring to FIGS. 8 to 14 of the drawings, the printhead 300 is described in greater detail. The printhead 300 comprises an array, which will be described in greater detail below, of nozzle assemblies. Referring initially to FIG. 8 of the drawings, a nozzle assembly is illustrated and is designated generally by the reference numeral 400.

The assembly 400 includes a silicon substrate or wafer 416 on which a dielectric layer 418 is deposited. A CMOS passivation layer 420 is deposited on the dielectric layer 418.

Each nozzle assembly 400 includes a nozzle 422 defining a nozzle opening 424, a connecting member in the form of a lever arm 426 and an actuator 428. The lever arm 426 connects the actuator 428 to the nozzle 422.

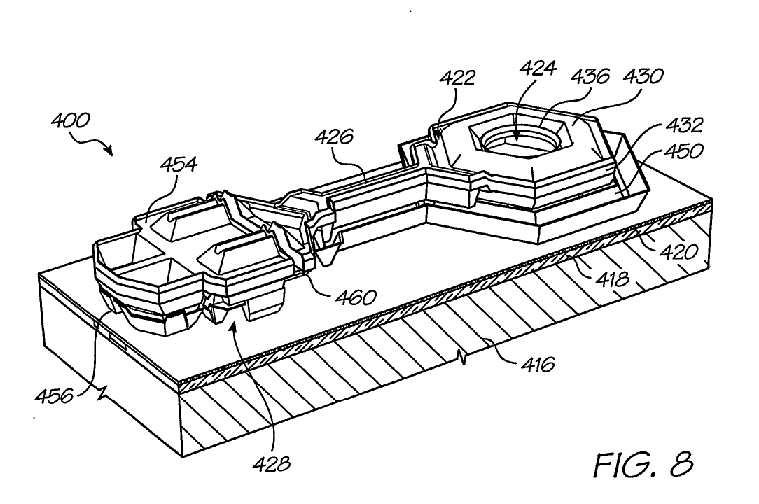

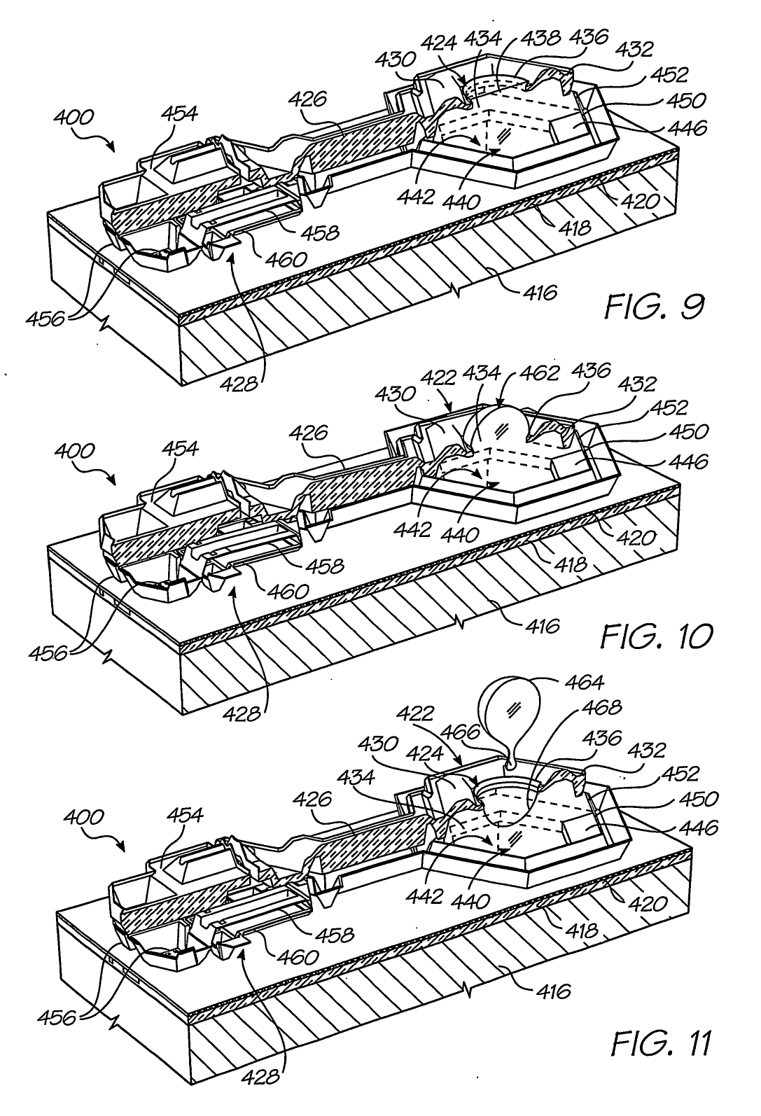

As shown in greater detail in FIGS. 9 to 11 of the drawings, the nozzle 422 comprises a crown portion 430 with a skirt portion 432 depending from the crown portion 430. The skirt portion 432 forms part of a peripheral wall of a nozzle chamber 434. The nozzle opening 424 is in fluid communication with the nozzle chamber 434. It is to be noted that the nozzle opening 424 is surrounded by a raised rim 436 which “pins” a meniscus 438 (FIG. 9) of a body of ink 440 in the nozzle chamber 434.

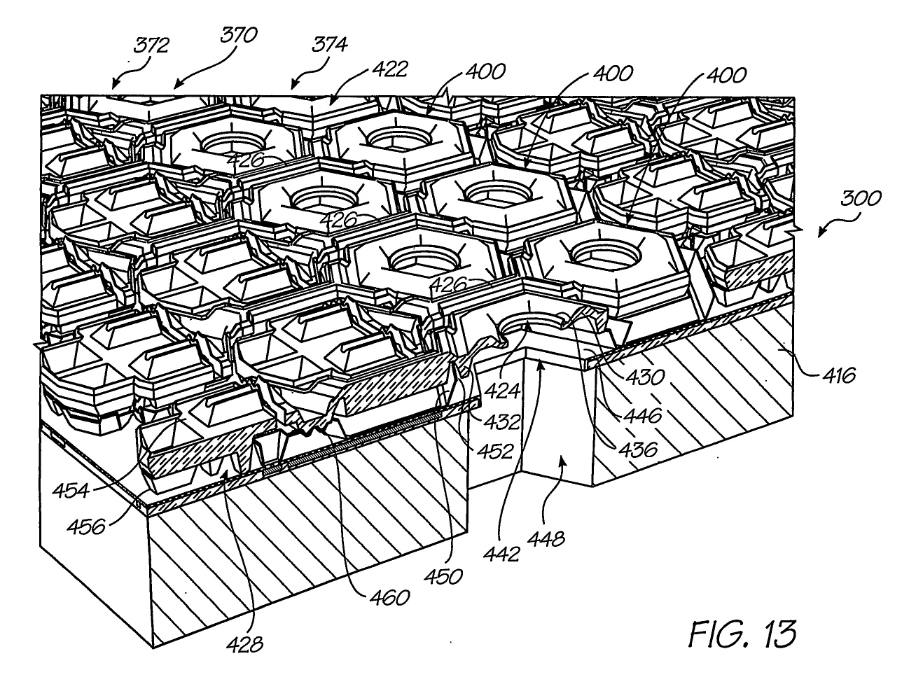

An ink inlet aperture 442 (shown most clearly in FIG. 13 of the drawings) is defined in a floor 446 of the nozzle chamber 434. The aperture 442 is in fluid communication with an ink inlet channel 448 defined through the substrate 416.

A wall portion 450 bounds the aperture 442 and extends upwardly from the floor portion 446. The skirt portion 432, as indicated above, of the nozzle 422 defines a first part of a peripheral wall of the nozzle chamber 434 and the wall portion 450 defines a second part of the peripheral wall of the nozzle chamber 434.

The wall 450 has an inwardly directed lip 452 at its free end which serves as a fluidic seal which inhibits the escape of ink when the nozzle 422 is displaced, as will be described in greater detail below. It will be appreciated that, due to the viscosity of the ink 440 and the small dimensions of the spacing between the lip 452 and the skirt portion 432, the inwardly directed lip 452 and surface tension function as a seal for inhibiting the escape of ink from the nozzle chamber 434.

The actuator 428 is a thermal bend actuator and is connected to an anchor 454 extending upwardly from the substrate 416 or, more particularly, from the CMOS passivation layer 420. The anchor 454 is mounted on conductive pads 456 which form an electrical connection with the actuator 428.

The actuator 428 comprises a pair of first, active beams 458 arranged above a pair of second, passive beams 460. In a preferred embodiment, both pairs of beams 458 and 460 are of, or include, a conductive ceramic material such as titanium nitride (TiN).

Both pairs of beams 458 and 460 have their first ends anchored to the anchor 454 and their opposed ends connected to the arm 426. When a current is caused to flow through the active beams 458 thermal expansion of the beams 458 result. As the passive beams 460, through which there is no current flow, do not expand at the same rate, a bending moment is created causing the arm 426 and, hence, the nozzle 422 to be displaced downwardly towards the substrate 416 as shown in FIG. 10 of the drawings. This causes ejection of ink through the nozzle opening 424 as shown at 462 in FIG. 10 of the drawings. When the source of heat is removed from the active beams 458, i.e. by stopping current flow, the nozzle 422 returns to its quiescent position as shown in FIG. 11 of the drawings. When the nozzle 422 returns to its quiescent position, an ink droplet 464 is formed as a result of the breaking of an ink droplet neck as illustrated at 466 in FIG. 11 of the drawings. The ink droplet 464 then travels on to the print media such as a sheet of paper. As a result of the formation of the ink droplet 464, a “negative” meniscus is formed as shown at 468 in FIG. 11 of the drawings. This “negative” meniscus 468 results in an inflow of ink 440 into the nozzle chamber 434 such that a new meniscus 438 is formed in readiness for the next ink drop ejection from the nozzle assembly 400.

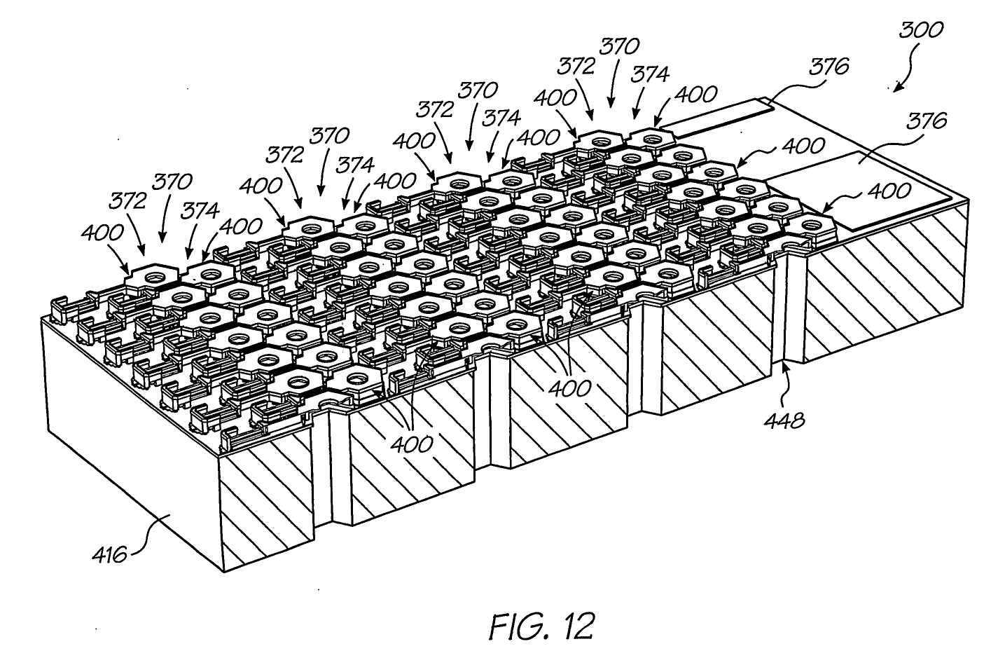

Referring now to FIGS. 12 to 14 of the drawings, a part of the printhead 300 is described in greater detail. The printhead 300 is a four color printhead. Accordingly, the printhead 300 includes four groups 370 of nozzle assemblies, one for each color. Each group 370 has its nozzle assemblies 400 arranged in two rows 372 and 374. One of the groups 370 is shown in greater detail in FIG. 13 of the drawings.

To facilitate close packing of the nozzle assemblies 400 in the rows 372 and 374, the nozzle assemblies 400 in the row 374 are offset or staggered with respect to the nozzle assemblies 400 in the row 372. Also, the nozzle assemblies 400 in the row 372 are spaced apart sufficiently far from each other to enable the lever arms 426 of the nozzle assemblies 400 in the row 374 to pass between adjacent nozzles 422 of the assemblies 400 in the row 372. It is to be noted that each nozzle assembly 400 is substantially dumbbell shaped so that the nozzles 422 in the row 372 nest between the nozzles 422 and the actuators 428 of adjacent nozzle assemblies 400 in the row 374.

Further, to facilitate close packing of the nozzles 422 in the rows 372 and 374, each nozzle 422 is substantially hexagonally shaped.

The substrate 416 has bond pads 376 arranged thereon which provide the electrical connections, via the pads 456, to the actuators 428 of the nozzle assemblies 400. These electrical connections are formed via the CMOS layer (not shown).

A nozzle guard 380 is mounted on the substrate 416 of the printhead 300. The nozzle guard 380 includes a body member 382 having a plurality of passages 384 defined therethrough. The passages 384 are in register with the nozzle openings 424 of the nozzle assemblies 400 of the printhead 300 such that, when ink is ejected from any one of the nozzle openings 424, the ink passes through the associated passage 384 before striking the print media.

The body member 382 is mounted in spaced relationship relative to the nozzle assemblies 400 by limbs or struts 386. One of the struts 836 has air inlet openings 388 defined therein.

When the printhead 300 is in operation, air is charged through the inlet openings 388 to be forced through the passages 384 together with ink travelling through the passages 384. The purpose of the air is to maintain the passages 384 clear of foreign particles. A danger exists that these foreign particles, such as dust particles, could fall onto the nozzle assemblies 400 adversely affecting their operation. With the provision of the air inlet openings 388 in the nozzle guard 380 this problem is, to a large extent, obviated.

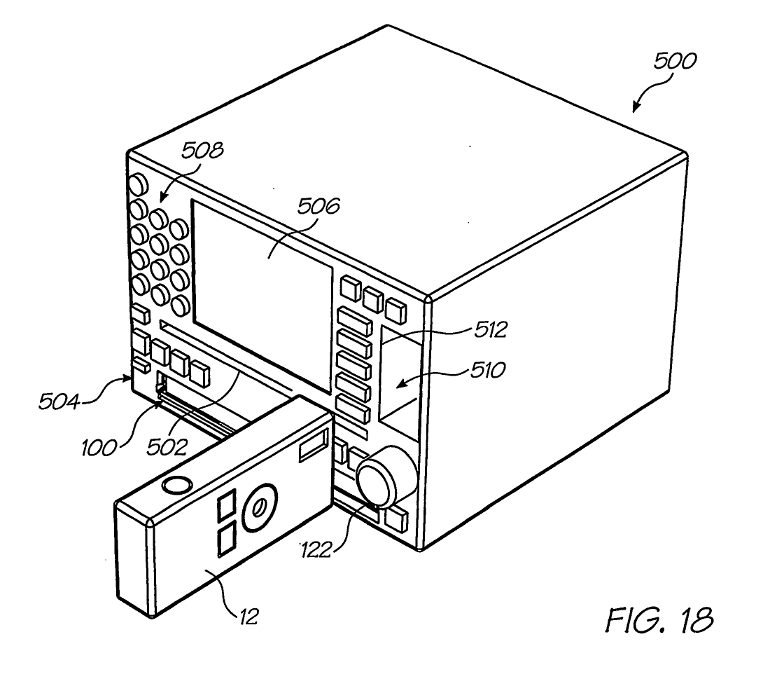

In another embodiment of the invention, the printer 100 is built into and forms part of an in-car entertainment (ICE) unit 500, as shown in FIG. 18 of the drawings.

The ICE unit 500, in addition to a CD player 502 and a radio having controls 504, includes a full color LCD 506. The unit 500 functions as a satellite navigation unit and may also be used for receiving television signals. The unit 500 incorporates a printer 100 of the type described above. The unit 500 includes a bank of control buttons 508. This bank of buttons 508 constitutes GPS controls and is used for satellite navigation purposes. In addition, the unit includes the user terminal 26 which is provided for controlling the printer 100 and the content printed by the printer 100.

In use, a driver of a vehicle who commits a traffic infringement or violation and is to be issued with a traffic violation notice is flagged down by a law enforcement officer who causes the driver of the vehicle to remove the vehicle to a side of the road. The law enforcement officer removes the user terminal 26, with its attached printing unit 16, from the cradle and approaches the vehicle which has been pulled over.

Registration details of the vehicle are entered via the user terminal. These data are then sent via the wireless communications sub-system 70 to a remote server where registration details of the vehicle are stored. The remote server is interrogated and information regarding the registration details is transmitted via the wireless communications sub-system 70 to the user terminal for entry into the traffic violation notice.

Similarly, a driver's license number of the driver of the vehicle is entered into the user terminal 26. Data regarding the license number are transmitted via the wireless communications sub-system 70 to another remote server where information regarding the driver are stored and which can be accessed via the driver license number. The information which is accessed includes the full names of the driver and a residential address of the driver. Once again, this information is forwarded via the wireless communications sub-system 70 to the user terminal 26 to be inserted into the traffic infringement notice.

The law enforcement officer determines the location of the incident by appropriate use of the user terminal 26 and the location determining apparatus 18. The place of the incident can then also be inserted into the traffic infringement notice.

By means of the user terminal 26 the law enforcement officer enters the time and date of the incident and the type of incident. In addition, the name and, if applicable, a registration number of the law enforcement officer are also entered via the data entry section of the user terminal 26.

After all the details of the traffic infringement have been completed the law enforcement officer signs the form, possibly digitally, to confirm its correctness. If manual signing of the form is required, the form is printed via the printer 100 of the printing unit 16. Two copies of the form are produced by the printer 100, one to be handed to the driver of the vehicle and the other to be retained by the law enforcement officer as a physical record of the incident.

If desired, information regarding the incident can also be transmitted via the wireless communications sub-system 70 to a remote server or location for further processing.

As a refinement of the system, the system 10 could include a digital camera 12 (FIG. 18) for use by the law enforcement officer to record data of an incident which may be necessary, such as at the scene of an accident Accordingly, the law enforcement officer may take photographs of the incident and have copies of the photographs printed at the scene of the accident by means of the camera 12. Conveniently, the camera 12 is received in a slot 510 defined in the ICE unit 500. The ICE unit 500 communicates with the printer 100 for enabling the photographs to be printed. In addition, by means of the wireless communications sub-system 70 data regarding the photograph can be transmitted to a remote location.

Accordingly, it is an advantage of the invention that a system 10 is provided which obviates the need for a law enforcement officer manually to enter all data regarding an incident. A large portion of a traffic infringement notice can be completed by appropriately accessing remote servers.

In addition, an instantaneous record is made of the traffic infringement notice which can be transmitted to the remote location for further processing.

Although the invention has been described with reference to a number of specific embodiments, it will be appreciated by those skilled in the art that the invention can be embodied in many other forms.

1. An information retrieval system for recording, at a predetermined location, particulars relating to an incident which has occurred at said predetermined location, the system including:
a user terminal for recording particulars of the incident;
a data collecting means with which the user terminal communicates for collecting data relevant to the incident;
a processing means, in communication with said data collecting means, for processing said collected data to provide formatted data suitable for printing; and
a printing unit associated with said user terminal for printing, at the location of said incident, said formatted data to provide information relating to said incident

2. The system of claim 1 which is carried in a conveyance, the user terminal being a portable unit for removal and use externally of the conveyance.

3. The system of claim 2 in which the printing unit is incorporated in the user terminal.

4. The system of claim 2 in which the data collecting means includes a location determining unit for determining said predetermined location.

5. The system of claim 4 in which the location determining unit provides data regarding the location as a set of co-ordinates.

6. The system of claim 5 in which the location determining unit comprises a global positioning system (GPS) receiver.

7. The system of claim 4 in which the data collecting means further includes an accessing means for accessing at least one database for obtaining further data relevant to the incident.

8. The system of claim 7 in which the accessing means includes a communications sub-system for accessing at least one remote database.

9. The system of claim 8 in which the communications sub-system is a wireless sub-system incorporated into the conveyance.

10. The system of claim 1 in which the processing means includes a layout engine in communication with the user terminal.

11. The system of claim 10 in which the layout engine performs, according to predetermined information, layout of data elements to be communicated to the printer so that, when printed on a suitable print media, the data are presented in a visually discernible form.

12. The system of claim 10 in which the processing means further comprises a data manipulating means in communication with the layout engine for manipulating the data to provide the formatted data.

13. The system of claim 12 in which the printing unit includes a printer controller, for receiving the formatted data to be printed, and a printer.

14. The system of claim 13 in which the printer is a full color printer.

15. The system of claim 14 in which said printer is a photo quality color printer.

16. The system of claim 14 in which the printer is an ink jet printer.

17. The system of claim 16 in which the printer comprises a pagewidth ink jet printhead.

18. The system of claim 17 in which the printhead comprises an array of nozzles, said array being fabricated by microelectromechanical techniques.

19. A method of retrieving information, at a predetermined location, of particulars relating to an incident which has occurred at the predetermined location the method including the steps of:
recording particulars of the incident which has occurred at said predetermined location;
collecting data relevant to the incident;
processing said collected data to provide formatted data suitable for printing; and
printing said formatted data, at said location of the incident and when required by a user, to provide the user with information relating to said incident.

20. The method of claim 19 which includes a user terminal mounted in a conveyance and a printer associated with the user terminal and in which the method includes printing the information via said printer.

21. The method of claim 19 which includes determining the location of the incident.

22. The method of claim 21 which includes providing the location of the incident as a set of co-ordinates.

23. The method of claim 19 which includes accessing at least one database for obtaining further data relevant to the incident.

24. The method of claim 23 which includes accessing at least one database remote from the location of the incident for obtaining further data relevant to the incident.

25. The method of claim 20 which includes performing, according to predetermined information, layout of content to be communicated to the printer so that, when printed on a suitable print media, the data are presented in a visually discernible form.

26. The method of claim 25 which includes manipulating said data prior to printing the data to provide said formatted data.

27. An information retrieval system for recording, at a predetermined location, particulars relating to an incident which has occurred at said predetermined location, the system being mounted in a vehicle and the system including:
a user terminal for recording particulars of the incident at said predetermined location, the user terminal being demountably arranged relative to the vehicle;
an onboard data collecting means with which the user terminal communicates for collecting data relevant to the incident;
a processing means, in communication with said data collecting means, for processing said collected data to provide formatted data suitable for printing; and
a printing unit arranged in said user terminal for printing said formatted data to provide information relating to said incident.

28. The system of claim 27 in which the data collecting means includes a location determining unit for determining the location of the vehicle.

29. The system of claim 28 which further includes a wireless communications sub-system for accessing at least one remote database to obtain details of at least one of a person involved in said incident and another vehicle involved in said incident.

30. A method of retrieving information, at a predetermined location and from a vehicle located at the location, of particulars relating to an incident which has occurred at the predetermined location, the method including the steps of:
recording, on a user terminal associated with said vehicle, particulars of the incident which has occurred at said predetermined location;
collecting data relevant to the incident;
processing said collected data to provide formatted data suitable for printing; and
printing said formatted data on a printer of the user terminal when required by a user to provide the user with information relating to said incident.

31. The method of claim 30 which includes determining the location of the vehicle.

32. The method of claim 31 which further includes accessing at least one remote database to obtain details of at least one of a person involved in said incident and another vehicle involved in said incident.

33. A system for retrieving and recording information relating to a traffic violation, the system being installed in a vehicle and the system including:
a user terminal operable by a user of the vehicle to record details of the traffic violation, the user terminal being demountably arranged relative to the vehicle;
a position sensing means carried by the vehicle for sensing the position of the vehicle to provide location data to the user terminal;
an accessing means, in communication with the user terminal, for accessing a database containing details of at least one of a driver which has committed the traffic violation and a vehicle involved in said traffic violation;
a layout engine responsive to the accessing means for processing data at least into textual data;
a pre-printing processing means which is connected to the layout engine and which processes the data from the layout engine to provide formatted data which is in a format which is suitable for printing; and
a printer contained in the user terminal for printing the formatted data, on demand, to provide at least one hard copy of a traffic infringement notice.

34. A method of retrieving and recording, from a vehicle, information relating to a traffic violation, the method including the steps of:
recording details of the traffic violation on a user terminal operable by a user of the vehicle, the user terminal being demountably arranged relative to the vehicle;
sensing the position of the vehicle to provide location data to the user terminal;
accessing a database containing details of at least one of a driver which has committed the traffic violation and a vehicle involved in said traffic violation;
processing data at least into textual data by means of a layout engine;
further processing the data from the layout engine to provide formatted data which is in a format which is suitable for printing; and
printing, on a printer contained in the user terminal, the formatted data, on demand, to provide at least one hard copy of a traffic infringement notice.
